(19) United States
(12) Patent Application Publication
(10) Pub. No.: US 2026/0103585 A1
(43) Pub. Date: Apr. 16, 2026

(54) FILM AND METHOD OF FORMING THE SAME

(71) Applicant: INDUSTRIAL TECHNOLOGY RESEARCH INSTITUTE, Hsinchu (TW)

(72) Inventors: Jian-Yi CHEN, Miaoli City (TW); Po-Ling SHIAO, Zhubei City (TW); Pei-Yin CHEN, Taipei City (TW); Mei-Chun LAI, Zhubei City (TW); Sheng-Yang LIU, Kaohsiung City (TW)

(73) Assignee: INDUSTRIAL TECHNOLOGY RESEARCH INSTITUTE, Hsinchu (TW)

(21) Appl. No.: 19/249,556

(22) Filed: Jun. 25, 2025

Related U.S. Application Data
(60) Provisional application No. 63/665,615, filed on Jun. 28, 2024.

(30) Foreign Application Priority Data
Dec. 18, 2024 (TW) 113149383

(51) Int. Cl. C08L 23/06; B29C 48/00; B29C 48/08; B29C 55/12; B29K 23/00; B29K 105/00; C08L 23/0807

(52) U.S. Cl. CPC C08L 23/06; C08L 23/0807; B29C 48/0018; B29C 48/08; B29C 55/12; B29K 2023/065; B29K 2105/0088; B29K 2105/0094; B29K 2995/0053; B29K 2995/0063

(57) ABSTRACT

A film includes a blend of high-density polyethylene (HDPE) and polyolefin elastomer (POE), and HDPE and POE have a weight ratio of 50:50 to 65:35. POE is a random copolymer of ethylene and C₆₋₈ α-olefin, wherein the ethylene and the C₆₋₈ α-olefin have a weight ratio of 60:40 to 90:10, and wherein HDPE has a density of 940 kg/m³ to 980 kg/m³ and a melt flow rate of 0.75 g/10 min to 2 g/10 min (2.16 kg/190° C.).

### CROSS REFERENCE TO RELATED APPLICATIONS

This application claims the benefit of U.S. Provisional Application No. 63/665,615 filed on Jun. 28, 2024, the entirety of which is/are incorporated by reference herein.

The present application is based on, and claims priority from, Taiwan Application Serial Number 113149383, filed on Dec. 18, 2024, the disclosure of which is hereby incorporated by reference herein in its entirety.

### TECHNICAL FIELD

The technical field relates to a film and a method of forming the same.

### BACKGROUND

An estimated 510,000 tons of plastic bags and plastic film are produced in Taiwan every year, while composite plastic soft packaging cannot be recycled, resulting in a huge amount of packaging waste. The EU promotes a single material for soft packaging, and PE materials have the potential for development as they can be recycled and reused multiple times. For film processing, it can be made by tenter frame biaxial oriented (BO, i.e., biaxially stretched) process where biaxial orientation is applied to the film to increase its physical strength, light transmittance, and thermal resistance. Most of the previous films produced by the tenter frame BO process include BO-PET, BO-PA, or BO-PP films. For PE films, the orientations are mostly done by blown oriented and uniaxially oriented. However, the blown oriented PE films have poor physical properties and light transmittance, which means that they cannot replace other BO films. The uniaxially oriented PE films have good physical strength and light transmittance only in a single direction, thus they are unsuitable for packaging bags that require higher puncture resistance and stiffness. Therefore, developing BO-PE films is crucial for the single-materialization of soft packaging.

### SUMMARY

One embodiment of the disclosure provides a film. The film includes a blend of high-density polyethylene (HDPE) and polyolefin elastomer (POE), and HDPE and POE have a weight ratio of 50:50 to 65:35. POE is a random copolymer of ethylene and C₆₋₈ α-olefin. The ethylene and the C₆₋₈ α-olefin have a weight ratio of 60:40 to 90:10. HDPE has a density of 940 kg/m³ to 980 kg/m³ and a melt flow rate of 0.75 g/10 min to 2 g/10 min (2.16 kg/190° C.).

One embodiment of the disclosure provides a method of forming a film, including blending HDPE and POE to form a blend, HDPE and POE have a weight ratio of 50:50 to 65:35, and POE is a random copolymer of ethylene and C₆₋₈ α-olefin, wherein the ethylene and the C₆₋₈ α-olefin have a weight ratio of 60:40 to 90:10; forming a thick film of the blend; placing the thick film in a film orientation machine; and biaxially orienting the thick film to form a thinner film, wherein HDPE has a density of 940 kg/m³ to 980 kg/m³ and a melt flow rate of 0.75 g/10 min to 2 g/10 min (2.16 kg/190° C.).

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides a film, including a blend of high-density polyethylene (HDPE) and polyolefin elastomer (POE), and HDPE and POE have a weight ratio of 50:50 to 65:35. In some embodiments, the film can be biaxially oriented from a thick film. An insufficient or excessive amount of HDPE may lead to rupture of the biaxially oriented film during the biaxial stretching process. POE is a random copolymer of ethylene and C₆₋₈ α-olefin, wherein the ethylene and the C₆₋₈ α-olefin have a weight ratio of 60:40 to 90:10. If the carbon number of the α-olefin is too low (e.g., α-butene), the biaxially oriented film of the blend will be prone to rupture during the biaxial stretching process. If the amount of ethylene in POE is too low, the biaxially oriented film will be prone to rupture during the biaxial orientation process due to the overly low melt point of the blend. If the amount of the ethylene in POE is too high, the thick film of the blend will be only axially oriented at a high orientation ratio in a single direction, and cannot be biaxially oriented.

In some embodiments, HDPE has a density of 940 kg/m³ to 980 kg/m³ and a melt flow rate of 0.75 g/10 min to 2 g/10 min (2.16 kg/190° C.). If the melt flow rate of HDPE is too low or too high, the biaxially oriented film of the blend may rupture during the biaxial orientation process.

In some embodiments, HDPE may be a single type of HDPE. Alternatively, HDPE may include a combination of several types of HDPEs, and the combined HDPE has the density and the melt flow rate as described.

In some embodiments, POE has a density of 880 kg/m³ to 930 kg/m³ and a melt flow rate of 1 g/10 min to 8 g/10 min (2.16 kg/190° C.). If the density of POE is too low, the film's appearance will be foggy due to the poor compatibility of the blend. If the melt flow rate of POE is too low, the biaxially oriented film may break during the biaxial orientation process. If the melt flow rate of POE is too high, the edges of the film may shrink and deform during the orientation process.

In some embodiments, POE may be a single type of POE. Alternatively, POE may include a combination of several types of POEs, and the combined POE has the density and the melt flow rate as described.

In some embodiments, the thinner film (film after the biaxial orientation process) has a thickness of 10 micrometers to 40 micrometers. If the film is too thin, the puncture-resistant strength of the film will be decreased. If the film is too thick, the light transmittance of the film will be decreased.

One embodiment of the disclosure provides a method of forming a film, including blending HDPE and POE to form a blend, where HDPE and POE have a weight ratio of 50:50 to 65:35. If the amount of HDPE is too low or too high, the biaxially oriented film of the blend may break during the biaxial orientation process. POE is a random copolymer of ethylene and C₆₋₈ α-olefin, wherein ethylene and C₆₋₈ α-olefin have a weight ratio of 60:40 to 90:10. If the carbon number of the α-olefin is too low (e.g., α-butene), the biaxially oriented film of the blend will easily break during the biaxial orientation process. If the amount of ethylene in POE is too low, the biaxially oriented film of the blend will easily break during the biaxial orientation process due to the overly low melt point of the blend. If the amount of ethylene in POE is too high, the thick film of the blend will only axially oriented at a high orientation ratio in a single direction, and cannot be biaxially oriented.

In some embodiments, HDPE has a density of 940 kg/m³ to 980 kg/m³ and a melt flow rate of 0.75 g/10 min to 2 g/10 min (2.16 kg/190° C.). If the melt flow rate of HDPE is too low or too high, the biaxially oriented film of the blend may break during the biaxial orientation process.

In some embodiments, HDPE may be a single type of HDPE. Alternatively, HDPE may include a combination of several types of HDPEs, and the combined HDPE has the density and the melt flow rate as described.

In some embodiments, POE has a density of 880 kg/m³ to 930 kg/m³ and a melt flow rate of 1 g/10 min to 8 g/10 min (2.16 kg/190° C.). If the density of POE is too low, the biaxially oriented film's appearance will be foggy. If the melt flow rate of POE is too low, the biaxially oriented film of the blend may break during the biaxial orientation process. If the melt flow rate of POE is too high, the edges of the biaxially oriented film may shrink and deform during the orientation process.

In some embodiments, POE may be a single type of POE. Alternatively, POE may include a combination of several types of POEs, and the combined POE has the density and the melt flow rate as described.

In some embodiments, after blending HDPE and POE to form a blend, the film forming method includes forming a thick film of the blend, and placing the thick film in a film orientation machine. Subsequently, the thick film is biaxially oriented to form a thinner film.

In some embodiments, the thick film is pre-heated to 100° C. to 130° C. (e.g., 115° C. to 125° C.) before being biaxially oriented. In some embodiments, the pre-heating temperature is lower, it will be difficult to orient the thick film. In some embodiments, the pre-heating temperature is higher, and the oriented film will easily break during the biaxial orientation process.

In some embodiments, the step of forming the thick film of the blend includes extrusion molding, blow molding, or calendaring molding. In some embodiments, the step of biaxially orienting the thick film is performed at an orientation ratio of 3*3 to 7*7.

Below, exemplary embodiments will be described in detail so as to be easily realized by a person having ordinary knowledge in the art. The inventive concept may be embodied in various forms without being limited to the exemplary embodiments set forth herein.

### EXAMPLES

In the following Examples, the densities of the polymers and the blends were measured according to the standard ASTM D792 (2008), and the melt flow rates (MFR) of the polymers and the blends were measured according to the standard ASTM D1238 (2013).

### Example 1

50 parts by weight of HDPE (LH901 commercially available from USI Corporation, having a density of 953 kg/m³ and a melt flow rate of 0.95 g/10 min (2.16 kg/190° C.)) and 50 parts by weight of POE (Engage 8450 commercially available from Dow Chemical, a random copolymer of ethylene and α-octene, ethylene and α-octene had a weight ratio of 60:40 to 80:20, having a density of 902 kg/m³ and a melt flow rate of 3 g/10 min (2.16 kg/190° C.)) were blended to form a blend. The blend was extruded to form a thick film, and then placed in a biaxial orientation machine to be pre-heated to 120° C. The thick film was then biaxially oriented at an orientation ratio of 5*5 to obtain a thinner film with a uniform thickness of 13 micrometers to 15 micrometers and a melting point of 126.7° C.

### Example 2

60 parts by weight of HDPE (LH901) and 40 parts by weight of POE (Engage 8450) were blended to form a blend. The blend was extruded to form a thick film, and then placed in a biaxial orientation machine to be pre-heated to 120° C. The thick film was then biaxially oriented at an orientation ratio of 4.5*4.5 to obtain a thinner film with a uniform thickness of 16 micrometers to 20 micrometers and a melting point of 131.1° C.

### Example 3

40 parts by weight of HDPE (LH901) and 15 parts by weight of HDPE (TAISOX 8003H commercially available from Formosa Plastics Group, having a density of 958 kg/m³ and a melt flow rate of 0.3 g/10 min (2.16 kg/190° C.)) were blended to obtain an HDPE blend (having a density of 954 kg/m³ and a melt flow rate of 0.97 g/10 min (2.16 kg/190° C.)). The resulting HDPE blend and 40 parts by weight of POE (Engage 8450) were blended to form a blend of HDPE/POE. The blend of HDPE/POE was extruded to form a thick film, and then placed in a biaxial orientation machine to be pre-heated to 120° C. The thick film was then biaxially oriented at an orientation ratio of 4*4 to obtain a thinner film with a uniform thickness of 22 micrometers to 25 micrometers and a melting point of 128.2° C.

### Example 4

54 parts by weight of HDPE (LH901) and 11 parts by weight of HDPE (TAISOX 8003H) were blended to obtain an HDPE blend (having a density of 954 kg/m³ and a melt flow rate of 1.13 g/10 min (2.16 kg/190° C.)). 11 parts by weight of POE (Engage 8402 commercially available from Dow Chemical, a random copolymer of ethylene and α-octene, ethylene and α-octene had a weight ratio of 60:40 to 80:20, having a density of 902 kg/m³ and a melt flow rate of 30 g/10 min (2.16 kg/190° C.)) and 24 parts by weight of POE (Engage 8450) were blended to obtain a POE blend (having a density of 902 kg/m³ and a melt flow rate of 6.3 g/10 min (2.16 kg/190° C.)). The resulting HDPE blend and the POE blend were blended to form a blend of HDPE/POE. The blend of HDPE/POE was extruded to form a thick film, and then placed in a biaxial orientation machine to be pre-heated to 120° C. The thick film was then biaxially oriented at an orientation ratio of 4*4 to obtain a thinner film with a uniform thickness of 20 micrometers to 24 micrometers and a melting point of 128.6° C.

### Comparative Example 1

100 parts by weight of POE (Engage 8450) was extruded to form a thick film, and then placed in a biaxial orientation machine to be pre-heated to 120° C. The POE thick film ruptured during the orientation process. As shown above, the thermal resistance of POE was insufficient.

### Comparative Example 2

30 parts by weight of HDPE (LH901) and 70 parts by weight of POE (Engage 8450) were blended to form a blend. The blend was extruded to form a thick film, and then placed in a biaxial orientation machine to be pre-heated to 120° C. The thick film was then biaxially oriented at an orientation ratio of 4*4, but a thinner film could not be formed (the film broke). As shown above, the blend with a POE amount that is too high could not be biaxially oriented.

### Comparative Example 3

70 parts by weight of HDPE (LH901) and 30 parts by weight of POE (Engage 8450) were blended to form a blend. The blend was extruded to form a thick film, and then placed in a biaxial orientation machine to be pre-heated to 120° C. The thick film was then biaxially oriented at an orientation ratio of 4*4, but a thinner film could not be formed (the film broke). As shown above, the blend with an HDPE amount that is too high could not be biaxially oriented.

### Comparative Example 4

100 parts by weight of HDPE (LH901) was extruded to form a thick film, and then placed in a biaxial orientation machine to be pre-heated to 120° C. The thick film was then biaxially oriented at an orientation ratio of 3*3, but a thinner film could not be formed (the film broke). As shown above, HDPE could not be biaxially oriented.

### Comparative Example 5

50 parts by weight of HDPE (LH901) and 50 parts by weight of linear low density polyethylene (LLDPE, Taisox 3220 commercially available from Formosa Plastics Group, having a density of 920 kg/m³ and a melt flow rate of 2 g/10 min (2.16 kg/190° C.)) were blended to form a blend. The blend was extruded to form a thick film, and then placed in a biaxial orientation machine to be pre-heated to 120° C. The thick film was then biaxially oriented at an orientation ratio of 3*3, but a thinner film could not be formed (the film broke). As shown above, the blend of HDPE and LLDPE could not be biaxially oriented.

### Comparative Example 6

50 parts by weight of HDPE (LH901) and 50 parts by weight of POE (Engage 7467 commercially available from Dow Chemical, a random copolymer of ethylene and α-butene, ethylene and α-butene had a weight ratio of 60:40 to 80:20, having a density of 862 kg/m³ and a melt flow rate of 1.2 g/10 min (2.16 kg/190° C.)) were blended to form a blend. The blend was extruded to form a thick film, and then placed in a biaxial orientation machine to be pre-heated to 120° C. The thick film was then biaxially oriented at an orientation ratio of 3*3, but a thinner film could not be formed (the film broke). As shown above, the blend of POE (copolymerized from α-olefin with an overly low carbon number and ethylene) and HDPE could not be biaxially oriented.

### Example 5

50 parts by weight of HDPE (LH901) and 50 parts by weight of POE (Exceed 3518CB commercially available from ExxonMobil Corporation, a random copolymer of ethylene and α-hexene, ethylene and α-hexene had a weight ratio of 80:20 to 90:10, having a density of 918 kg/m³ and a melt flow rate of 3.5 g/10 min (2.16 kg/190° C.)) were blended to form a blend. The blend was extruded to form a thick film, and then placed in a biaxial orientation machine to be pre-heated to 120° C. The thick film was then biaxially oriented at an orientation ratio of 3.5*3.5 to obtain a thinner film with a uniform thickness of 29 micrometers to 35 micrometers and a melting point of 126.4° C.

### Comparative Example 7

50 parts by weight of HDPE (Taisox 8003H commercially available from Formosa Plastics Group, having a density of 958 kg/m³ and a melt flow rate of 0.3 g/10 min (2.16 kg/190° C.)) and 50 parts by weight of POE (Engage 8450) were blended to forma blend. The blend was extruded to form a thick film, and then placed in a biaxial orientation machine to be pre-heated to 120° C. The thick film was then biaxially oriented at an orientation ratio of 3*3, but a thinner film could not be formed (the film broke). As shown above, the blend of POE and HDPE, where the HDPE had a melt flow rate that was too low, could not be biaxially oriented.

### Comparative Example 8

65 parts by weight of HDPE (Taisox 8003H) and 35 parts by weight of POE (Engage 8450) were blended to form a blend. The blend was extruded to form a thick film, and then placed in a biaxial orientation machine to be pre-heated to 120° C. The thick film was then biaxially oriented at an orientation ratio of 3*3, but a thinner film could not be formed (the film broke). As shown above, the blend of POE and HDPE, where the HDPE had a melt flow rate that was too low, could not be biaxially oriented.

### Comparative Example 9

50 parts by weight of HDPE (LH606 commercially available from USI Corporation, having a density of 962 kg/m³ and a melt flow rate of 6 g/10 min (2.16 kg/190° C.)) and 50 parts by weight of POE (Engage 8450) were blended to form a blend. The blend was extruded to form a thick film, and then placed in a biaxial orientation machine to be pre-heated to 120° C. The thick film was then biaxially oriented at an orientation ratio of 3*3, but a thinner film could not be formed (the film broke). As shown above, the blend of POE and HDPE, where the HDPE had a melt flow rate that was too high, could not be biaxially oriented.

### Comparative Example 10

65 parts by weight of HDPE (LH606) and 35 parts by weight of POE (Engage 8450) were blended to form a blend. The blend was extruded to form a thick film, and then placed in a biaxial orientation machine to be pre-heated to 120° C. The thick film was then biaxially oriented at an orientation ratio of 3*3, but a thinner film could not be formed (the film broke). As shown above, the blend of POE and HDPE, where the HDPE had a melt flow rate that was too high, could not be biaxially oriented.

### Example 6

50 parts by weight of HDPE (Taisox 8010 commercially available from Formosa Plastics Group, having a density of 958 kg/m³ and a melt flow rate of 1 g/10 min (2.16 kg/190° C.)) and 50 parts by weight of POE (Engage 8450) were blended to form a blend. The blend was extruded to form a thick film, and then placed in a biaxial orientation machine to be pre-heated to 120° C. The thick film was then biaxially oriented at an orientation ratio of 4*4 to obtain a thinner film with a uniform thickness of 21 micrometers to 24 micrometers and a melting point of 128.4° C.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A film, comprising:
a blend of high-density polyethylene (HDPE) and polyolefin elastomer (POE), and the HDPE and the POE have a weight ratio of 50:50 to 65:35,
wherein the POE is a random copolymer of ethylene and C₆₋₈ α-olefin, wherein the ethylene and the C₆₋₈ α-olefin have a weight ratio of 60:40 to 90:10, and
wherein the HDPE has a density of 940 kg/m³ to 980 kg/m³ and a melt flow rate of 0.75 g/10 min to 2 g/10 min (2.16 kg/190° C.).

2. The film as claimed in claim 1, wherein the POE has a density of 880 kg/m³ to 930 kg/m³ and a melt flow rate of 1 g/10 min to 8 g/10 min (2.16 kg/190° C.).

3. The film as claimed in claim 1, wherein the film has a thickness of 10 micrometers to 40 micrometers.

4. A method of forming a film, comprising:
blending HDPE and POE to form a blend, wherein the HDPE and the POE have a weight ratio of 50:50 to 65:35, and the POE is a random copolymer of ethylene and C₆₋₈ α-olefin, wherein the ethylene and the C₆₋₈ α-olefin have a weight ratio of 60:40 to 90:10;
forming a thick film of the blend;
placing the thick film in a film orientation machine; and
biaxially orienting the thick film to form a thinner film,
wherein the HDPE has a density of 940 kg/m³ to 980 kg/m³ and a melt flow rate of 0.75 g/10 min to 2 g/10 min (2.16 kg/190° C.).

5. The method as claimed in claim 4, wherein the POE has a density of 880 kg/m³ to 930 kg/m³ and a melt flow rate of 1 g/10 min to 8 g/10 min (2.16 kg/190° C.).

6. The method as claimed in claim 4, wherein the step of biaxially orienting the thick film is performed at an orientation ratio of 3*3 to 7*7.
